(19) United States
(12) Patent Application Publication
(10) Pub. No.: US 2010/0246999 A1
(43) Pub. Date: Sep. 30, 2010

(54) Method and Apparatus for Editing Large Quantities of Data Extracted from Documents

(76) Inventors: Michael Tillberg, Brentwood, NH (US); George L. Gaines, III, Boxford, MA (US); Kevin K. Pang, Canto, MA (US)

Correspondence Address: NORMA E HENDERSON;HENDERSON PATENT LAW, 13 JEFFERSON DR, LONDONDERRY, NH, 03053, US

(21) Appl. No.: 12/679,135

(22) PCT Filed: Sep. 22, 2008
(86) PCT No.: PCT/US08/77292

§ 371 Date: Mar. 19, 2010

Related U.S. Application Data
(60) Provisional application No. 60/994,398, filed on Sep. 20, 2007.

(51) Int. Cl. G06K 9/03

(52) U.S. Cl. 382/309

(57) ABSTRACT

An editing system for editing and verifying data extracted from paper documents or electronic image files comprises an editing subsystem that processes the extracted data for editing according to data type and a validation subsystem. The editing subsystem comprises an automated processing utility that compares extracted data with at least one lexicon to determine if correction is required, a character level editing utility that presents the extracted data at the character level in an editable form for checking and correction at the character level, an element level editing utility for checking and correction at the element level, and a full form element level editing utility for checking and correction at the full form element level. The validation subsystem assists in achieving required accuracy rates and comprises a consistency check utility, an adjudication utility, and an optional statistical verification utility.

### RELATED APPLICATIONS

This application claims the benefit of U.S. Provisional Application Ser. No. 60/994,398, filed Sep. 20, 2007, the entire disclosure of which is herein incorporated by reference.

### FIELD OF THE TECHNOLOGY

The present invention relates to electronic data management systems and, in particular, to data extraction technology.

### BACKGROUND

Forms and documents are efficient frameworks for capturing and organizing data into information on a page. Many informational workflows and decision-making processes depend on the thoroughness and quality of historical and longitudinal information. A huge stumbling block in informational technology is the ability to share data and information from the forms and documents generated from a particular workflow or period in time with others. Data is locked within the document, making the data difficult to leverage, share, and use as a knowledge source. Because of the static nature of documents and their images, data that resides in documents from one workflow cannot be easily shared into, and with, other documents and workflows.

Existing electronic data capture systems, which typically utilize keyboard-based input, emphasize a ‘day-forward’ philosophy of only using information that can be entered via the keyboard. This severely limits data and information usage to only very current data, with a major bottleneck being the implementation of sophisticated and costly data entry systems and interfaces. These systems cannot help with the integration of historical data that already exists on forms or documents (such as, for example, paper and images of paper, such as PDFs and TIFF images) or with workflows that are not traditionally keyboard-based, such as forms and documents that contain handwritten input.

Given the increasing complexity of work environments and the detailed decisions required to manage them, the inability to productively access historical data becomes a severe limitation to information sharing, data aggregation, and longitudinal and horizontal analyses that can lead to more informed workflow processes and key decision making. In addition, many valuable records, such as, for example, birth certificates, death certificates, prior medical conditions, environmental reports, applications, and benefit filings, currently exist only on paper or, possibly, as scanned images. Extracting and productively processing and recognizing the data that exist on these forms is an important part of creating interoperable and auditable sources of information that is critical to many government processes, such as, but not limited to, homeland security, Medicare, Medicaid, Social Security, and administration of veterans' benefits.

What is needed, therefore, is a system that can “atomize” a document into its constituent elements, while retaining the context and meaning of each individual element so that each captured element can be propagated and shared with other workflows, visualization schemes, and learning mechanisms. Data that is processed this way can then be aggregated and analyzed within its own and other contexts, and can be otherwise leveraged, i.e., “capture once, used many times”, something that cannot be done with paper or scanned images of paper documents. In some instances, simply viewing extracted elements as images within context is sufficient to dramatically enhance dependent information workflows; for example, a doctor being able to view all blood pressure readings taken within the last two years, as extracted from a patient's medical record file. In other instances, recognition, and validation of the extracted image needs to be performed because of search and/or computation requirements of the data, such as, for example, creation and validation of record data when creating an identity database from historical forms.

Additionally, the accuracy requirements of the workflows and decision processes for the accessible data may be very high. For example, financial and medical record usage requires nearly 100% fidelity of the data within a data repository in order to be useful. Otherwise, legal, ethical, and operational issues preclude the automated extraction and recognition of the data. At present, the completely automated data extraction systems currently available are not sufficiently accurate to accommodate these requirements. Manual intervention in the form of editing or direct data entry is required, thereby dramatically increasing the cost, time and effort of reliably extracting the data from documents. Furthermore, multiple manual passes over the same data may be required in order to achieve the levels of accuracy needed.

### SUMMARY

The present invention is an electronic data management system and method employing data extraction technology to provide high accuracy data transfer and editing from paper documents and scanned images into electronic format machine text. In one aspect, the present invention is a highly controlled, automated process that rapidly, and at high volume, converts input images of handwritten text, check marks, filled in circles, and/or machine print extracted from forms and documents into high accuracy recognized text, Boolean mark results, and numeric data. The process integrates existing machine-driven recognition capabilities into a workflow that flexibly controls the passage of images and their recognized parts among available recognition and editing steps. The level of accuracy achievable with this process provides data of a quality suitable for integration into databases.

In one aspect, the present invention is a system for editing and verifying data extracted from paper documents or electronic image files. In a preferred embodiment, the present invention comprises an editing subsystem and a validation subsystem. The editing subsystem processes the extracted data for editing according to data type and comprises an automated processing utility that compares extracted data with at least one lexicon to determine if correction is required, a character level editing utility that presents the extracted data at the character level in an editable form for checking and correction at the character level, an element level editing utility for checking and correction at the element level, and a full form element level editing utility for checking and correction at the full form element level. The validation subsystem assists in achieving required accuracy rates and comprises a consistency check utility that identifies errors by comparing the extracted data to at least one set of lexicons or business rules, an adjudication utility that resolves incongruencies in extracted data, and an optional statistical verification utility that determines the accuracy of an editing path by comparing results from the editing path to results from an editing path known to have a predetermined accuracy threshold.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a block diagram of a preferred embodiment of a data editing system, according to one aspect of the present invention;

FIG. 2 is a block diagram of a preferred embodiment of a subsystem for input type discrimination, according to one aspect of the present invention;

FIG. 3 is a block diagram of a preferred embodiment of a subsystem for automated processing and editing, according to one aspect of the present invention;

FIG. 4 is a block diagram of a preferred embodiment of a subsystem for character level processing, according to one aspect of the present invention;

FIG. 5 is a screenshot depicting an exemplary embodiment of the editing user interface for character level editing, according to one aspect of the present invention;

FIG. 6 is a block diagram of a preferred embodiment of a subsystem for element level processing, according to one aspect of the present invention;

FIG. 7 is a screenshot depicting exemplary element level editing, according to one aspect of the present invention;

FIG. 8 is a screenshot depicting another example of element level editing;

FIG. 9 is a block diagram of a preferred embodiment of a subsystem for full form element level processing, according to one aspect of the present invention;

FIG. 10 is a screenshot depicting exemplary full form element level processing, according to one aspect of the present invention;

FIG. 11 is a screenshot depicting another example of full form element level processing;

FIG. 12 is a block diagram of a preferred embodiment of a subsystem for implementing consistency checks, according to one aspect of the present invention;

FIG. 13 is a screenshot depicting exemplary errors detected using consistency checks, according to one aspect of the present invention;

FIG. 14 is a block diagram of a preferred embodiment of a subsystem for implementing the adjudication process, according to one aspect of the present invention; and

FIG. 15 is a block diagram of a preferred embodiment of a subsystem for implementing the statistical verification process, according to one aspect of the present invention.

### DETAILED DESCRIPTION

The present invention is a highly controlled, automated process and system that rapidly, and at high volume, converts input images of handwritten text, check marks, filled in circles, and/or machine print extracted from forms and documents into high accuracy (>99%) recognized text, Boolean mark results, and numeric data. The process integrates machine-driven handwriting optical mark recognition (OMR) and optical character recognition (OCR) capabilities into a workflow that flexibly controls the passage of images and their recognized parts among and between recognition and editing steps. The present invention achieves a high level of accuracy, providing data that is of sufficient quality for integration into databases for the purpose of content-based data and document search along any of the processed and recognized input elements, as well as for aggregation, analysis, and computation.

In a preferred embodiment, quality control gates are created at a minimum of three distinct and successive levels: the character level, the field or element level, and the form and document level. At each successive level, algorithms are used to score, threshold, gate, and statistically measure the accuracy of input from the previous level. The process provides flexible control over the presentation and analysis of the images undergoing recognition, both at the automated and manual recognition levels. Furthermore, the output at any level may be compared with expected results, such as quantities of specific characters and character types (e.g., numbers versus alpha characters), lexicons, and date formats.

In a preferred embodiment, the system provides the ability to precisely map constituent characters, as depicted in an image, to constituent recognized characters within a text string. The string itself is mapped to its precise positional, relational, and contextual position within the document image, thereby keeping recognized characters, words, sentences, and data as accurate positional representations of the data extracted from the document images. Text strings that contain characters having sub-threshold confidence scores from applied handwriting and machine text recognition algorithms, and thus are suspect with respect to accuracy, may be collected and moved to the element level editing process. The next level of quality control gating is to view the suspect element and edit or accept it, as appropriate. Elements that remain resistant to high confidence recognition and validation are then passed to multi-field or full document viewing and editing, where position, context, and positional relationships to other data and structural elements often provide clues to content. Each level of processing may be optionally adjusted to increase throughput and/or to guarantee specified levels of output accuracy.

The present invention is particularly advantageous in distributed workflows, wherein multiple recognition engines and editors can simultaneously operate on the data to provide high throughput processing of extracted data. For example, as high accuracy score, high confidence characters are reassembled back into their cognate text strings, strings can be matched or grouped together algorithmically to validate separate outputs via regular expression and logical relationships. For example, output ‘zip code’ string (as defined by the regular expression of a five digit number) should correlate to output ‘town’ string, which should further correlate to ‘street’ string, and output ‘age’ should correlate with output ‘birth date.’ External data sources can optionally be automatically accessed in order to provide further logical correlation and validation at the algorithmic level. In addition, for fields that do not achieve high constituent character accuracy scores, or with output that does not logically correlate, the system accommodates the use of voting engines and/or multiple viewers in order to edit and validate the data.

Statistical process control is provided by the system, with all work in process, from individual character to individual data element, can optionally be viewed, audited, and measured for accuracy of processing. Scoring and validation activities at the element and form level can be used to set up heuristic loops that allow optimization and tuning of recognition, processing, and scoring algorithms. The overall system is heuristic, providing higher accuracy and faster processing rates with increasing volume from a given corpus of documents and forms.

As used herein, the following terms expressly include, but are not to be limited to:

“Adjudication” means a process that receives differing results from an editing module for a single element and determines what the final result should be. Adjudication is preferably performed by a party other than the parties that are involved in providing the initial results.
“Editing Path” means the sequence of modules and processes used for a document or set of documents that corresponds to the data flow through the system.
“Field” or “Element” means a bounded area within a document that generally requires a single input string.
“Modules” means self-contained processes that may be used individually or in conjunction to provide editing or validation/verification capabilities. The modules are used sequentially in an Editing Path.
“Statistical Verification” means a process that selects a data set (generally randomized selection) and uses sufficient editing to provide a ground truth for the data set. The ground truth is then compared with the standard output of the editing for the same data set to provide accuracy levels for the editing module.

The present invention takes advantage of the fact that data-containing documents for a given informational workflow generally have constraints for that data, typically reflected by topic, physical location, and relationship to other data elements within the document. Chapters, paragraphs, pages, and fields are all levels of organization within a document and provide distinct informational and relational content for the document. Structured documents, which are documents that are designed to capture specific data in a standardized way, generally have the greatest levels of organization. The fields and elements within structured documents often have restrictions on the data that may be entered into them. These restrictions provide substrates for validation and recognition possibilities. Examples of the restrictions include, but are not limited to, date fields, numeric fields (such as, but not limited to, phone numbers, social security numbers, and identification numbers), fields capturing specific topics, and redundant fields. The fields within a form or document may further have redundancies that may be used for validation and comparison. For example, within a multipage document, there may exist several date fields that should have the same date.

The simplest identifiable element within a document is the character, punctuation and separator (dash, slash, space). Since there exist only 52 letters (upper and lower case), 10 digits, and a handful of major separators [( )%$!+*=,.;:’”/?] within the English language, roughly 85 character elements may be extracted, identified, and validated. Key to the invention is the ability to map the precise location from whence the character element image was extracted for recognition. By preserving this location information, the character elements may be isolated and checked, edited, or validated and then reassembled into their constituent strings.

This provides at least two advantages for editing and checking. Firstly, hundreds to thousands of the same character may be visualized and checked very rapidly with the appropriate viewing tool. The speed of checking and editing characters in this manner is often much faster and more accurate than checking and editing strings of disparate characters. A key advantage of this invention is the ability to generate views of full pages of the characters in rapid succession, minimizing the downtime between page refreshes. Secondly, the editing and checking of the characters in this manner does not require any knowledge about the strings from which they were derived. Hence, no knowledge about the spelling and/or proper usage of the strings within a document is required. In addition, since only the separated characters are viewed, no information that may be deemed sensitive or confidential is available to the human checkers and editors, allowing the dissemination, editing and correcting of sensitive and confidential information without constraint.

In a preferred embodiment, the data editing system of the present invention is implemented via a series of software or firmware modules that interact with the appropriate hardware to perform all the steps of the invention. Modules in a preferred embodiment of the present invention include Input type identification, Automated processing, Character level editing, Element level editing, Full form level element editing, Consistency checks, Adjudication, Statistical Verification, and User statistics.

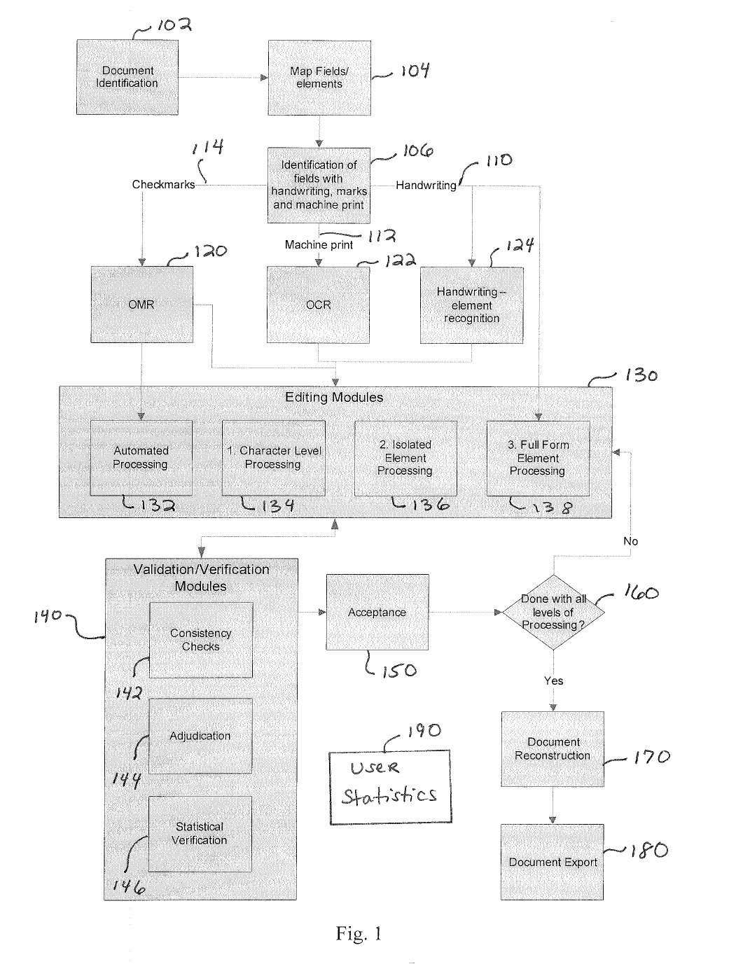

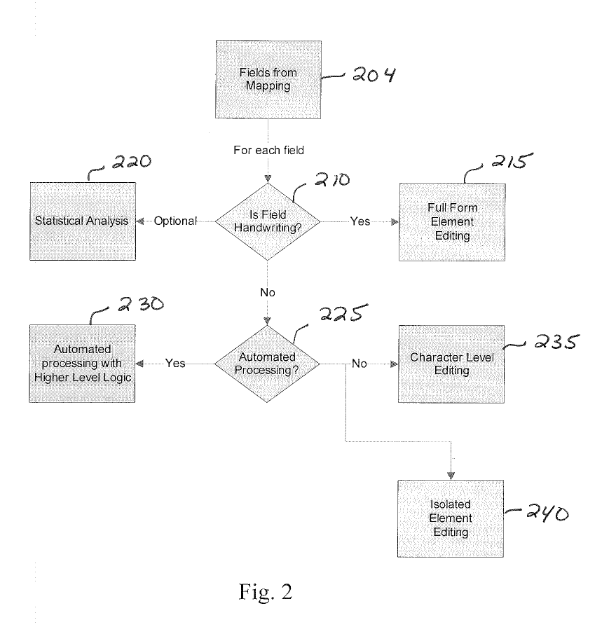

FIG. 1 is a block diagram depicting a preferred embodiment of a data editing system according to one aspect of the present invention, while FIGS. 2-15 provide examples of the modules that may be incorporated into a dataflow, along with exemplary screenshots from a preferred implementation. In FIG. 1, Document Identification 102 is an automated or manual indexing or identification of the documents, usually based on a set of document templates. There are many means known in the art by which a document (canned or electronic images of document) may be automatically identified, any of which may be advantageously employed by the present invention. A preferred embodiment employs the method taught by U.S. Pat. App. Pub. No. 2007/0168382 [“Document analysis system for integration of paper records into a searchable electronic database”, Tillberg et al.], which is herein incorporated by reference in its entirety.

The system proceeds with mapping and extraction 104 of the elements and fields within the document. The mapping needs to be accurate and precise, as the accuracy of the recognition processes is dramatically reduced if the fields within the document images are not correctly aligned. There are many processes known in the art for automatically mapping and extracting fields from documents, any of which may be advantageously employed by the present invention. A preferred embodiment employs the method taught by U.S. Pat. App. Pub. No. 2007/0168382.

The next step in the process is recognition of the input data, which starts by identification 106 of the type of data input for each individual field. In the preferred embodiment, the types may be handwriting 110, machine print 112, and marks 114. Recognition engines normally include the programs needed to recognize the identified machine print characters, checkmarks, and handwriting. There exist a number of commercial and open source programs that may be incorporated into these engines, such as, but not limited to, optical character recognition (OCR) for stamps and machine text, optical mark recognition (OMR) for checkboxes, advanced intelligent character recognition (aICR) for simple handstrokes, and handwriting recognition (HWR) for general and cursive writing.

Marks 114 may include, but are not limited to, checkmarks and “X′s”, as well as filled in circles. The mark-containing elements or fields are preferably identified using a template document. Any field that is deemed to be a “check-box” or any field requiring the user to color in an area will be designated as such in the document template. When mapping and data extraction occurs, the entries in mark fields are typically recognized using Optical Mark Recognition (OMR) 120.

Fields that are designated in the document templates as having typed or written input undergo analysis to determine which input type is present in every image. For fields that are machine print 112 (i.e. typed in or stamped), optical character recognition (OCR) 122 or other means of machine print recognition is applied. Handwriting 110 may be simple stroke or general, which includes more complex writing and cursive writing. For fields containing specific types of simple handwritten data 110, such as dates and numbers, automated handwriting recognition 124 using, for example, advanced intelligent character recognition (aICR), may be applied. For those fields determined to contain general handwriting, the input can then be exported for manual recognition and data entry, or alternatively, may be processed with handwriting recognition (HWR) algorithms.

With the exception of general cursive handwriting, where segmentation of characters is a problem and therefore recognition occurs at the field/element level, all of the recognized characters and elements are then moved into the editing subsystem 130. General handwriting is displayed in a data input editor as element-separated units for visualization, quality assurance, and editing where necessary. As shown in FIG. 1, handwriting images 110 are moved into either the Isolated Element 136 or Full Form Element 138 Processing module, depending on processing strategy.

Once the image data within the field or element is converted to machine text or marks, the images and the corresponding recognized output are moved into editing subsystem 130. The editing subsystem 130 contains a number of modules, each allowing rapid and accurate checking and editing, either by human editors or by comparisons with lexicons of predetermined entries using Automated processing 132. Each level of processing module, Character Level Processing 134, Isolated Element Processing 136, and Full Form Element Processing 138, provides a presentation view that maximizes the speed and accuracy of the editing and quality assurance processes for human editors. The data may be processed through the editing modules in any order, depending upon the needs of the editors and the requirements of the final recognition accuracy. However, for a typical project, the editing path begins with character level processing 134 and ends with full form element processing 138.

Validation and verification subsystem 140 may be used at any level in the editing process. Consistency checks module 142 provides a set of applicable lexicons and business rules that may be used to find potential errors based on comparisons with those lexicons and rules. Recognized data that does not pass the consistency checks may be re-processed or re-routed through the editing modules or moved to Adjudication module 144. Adjudication module 144 provides a dataflow which permits another editor, or other automated algorithms to be invoked, to make a specific call for incongruent matched data, such as, but not limited to, different calls from redundant data entered for a single element, or for elements that appear visually correct but are outside the lexicons for consistency checks. When required, statistical verification 146 may be accomplished by selecting a subset of data and using an editing path that provides a very high level of accuracy. The results from the editing path may be considered ground truth and used to compare the output of the same data from the normal editing paths. This comparison is used to determine accuracy of the normal path. Based on the accuracy, alterations of the normal path may be made, either to increase the accuracy of the output of the system or decrease the effort required.

The validated data is then accepted via Acceptance process 150. If all level of processing are complete 160, the validated data is passed to document reconstruction 170 and exported 180 to the database (or other data repository). Otherwise, it is moved to the yet another level of editing in Editing subsystem 130.

Optional User statistics module 190 provides management data on the operation and efficiency of the editing process and users. In an embodiment employing this module, data is captured about the use of each module. The raw data used is pulled from all stages of the process and from the server logs in order to obtain timing data. For example, each editor may be monitored for speed of data validation or input. That data may then be compared across users of the system in order to identify high and low performers. Incorporation of the statistical verification data on a per user and per module level may be used to compare both speed and accuracy of individual users within and across modules. This data may be used to inform management decisions about deployment of resources. In a preferred implementation, Microsoft Excel is used to manage the statistics.

A key aspect of the present invention is the capacity to present characters, elements or pages in ways that optimize the editor's ability to scan rapidly to find misidentified items from recognition processes. This is accomplished using several approaches, including score-based indexing, alphabetical indexing or other relationship-based grouping, grouping characters or elements based on recognized value, and/or full form presentation. Score-based indexing is the tabular presentation of items (characters or elements) in a pattern from poorest to best recognition score. Alphabetical indexing for elements is the columnar or tabular presentation of elements based on alphabetical results from recognition. Full form presentation is the presentation of a set of the same forms with navigation among fields or elements using tabbing with highlighting. A key to full-form presentation is the flexible preselection of specific fields for editing, from one or a few fields to all fields.

An advantage of a preferred embodiment of the present invention is rapid generation of page views. The speed of data entry using page views of characters, elements, or full forms is impacted by the waiting time between views and data entry application screens. In some embodiments, the application will be run as a web service or a client-server system. These embodiments require novel approaches to minimize the page refresh times, given the large amounts of data that is needed for each view. One embodiment employs a technique similar to that used in computer-based gaming, called double buffering. This approach is analogous to pre-fetching, where an internet browser utilizes browser idle time to specifically download links that may be utilized in the near future.

There are three basic states in the viewing cycle: images coming into the system from the database and server, images in the browser that are being operated upon by the user, and saved data and images being sent back to the database and server. This separation permits upload and saving of data to occur in the background while the user is doing the editing. This is advantageous since, in several stages of the process, the user is looking at multiple images on the screen at the same time. Loading those images into the browser might take multiple seconds, depending at least partially on the speed of the internet connection. Because the downloading of the new images and saving of the manipulated images and data occurs in the background, the user experiences a more “local desktop” sense of data retrieval and saving.

As shown in FIG. 1, after document identification 102 and mapping and extraction 104 of the elements and fields within the document, the process of the present invention continues with identification 106 of the type of data input for each individual field. FIG. 2 is a block diagram of a preferred embodiment of a subsystem for input type discrimination, according to this aspect of the present invention. In FIG. 2, if the data obtained 204 from the mapping process is determined to be handwriting 210, it is sent to full form editing module 215, with optional statistical analysis 220. Otherwise, if automated processing 225 is desired and possible, the data is sent to automated processing module 230. If not, the data is moved to character level editing 235 or isolated element editing 240, depending on data type and processing strategy.

A key part of the present invention is the editing subsystem, which provides flexibility to the editing, validation, and adjudication data and workflows. In a typical embodiment, the edit path for recognized data is set up to start at the character or element level of editing and data is passed through various levels of quality assurance and editing steps until it is deposited in the database. However, additional fields may be made available for validation or input of a specific field. Often a field may be edited based on the specific information present in another field, and hence having the ability to view data in that other field enhances the ability of the editor to make correct edits. Additionally, depending upon data found in other validated fields, various editor assist mechanisms, such as, but not limited to, drop-down boxes and type-ahead text entry, may be employed. For example, if the form under editing has both “county” and “town” fields, the “town” text entry may be limited to only those towns in that county. This functionality may be implemented by any of the many methods known in the art including, but not limited to, a limited lexicon of possible input selections for the drop-down or type-ahead text entry.

The specific edit path chosen is determined by the level of accuracy required in the document for recognized data, the ability of the system to automatically validate and edit that data at any step, and the data entry or editing skills of the editors. Partially through this mechanism, the process provides a means to derive accuracy rates at each step in the process. The editing path employed is determined by selecting modules within the editing module set. The option to have multiple views of the same data for editing and verification is easily accomplished via this process, by replicating the data set and passing it to the same module with different editors. Hence, double data editing may be used at any level of the process. Any edits that are not congruent may be reprocessed using alternative image processing, signal filtering, and recognition algorithms or may be chosen to be moved through another round of editing, moved to another level of editing, or passed to an adjudication module, each of which provides the editors with more context in which to make editing decisions.

In a simple editing path example, editing of machine print data is achieved in a stepwise manner, starting at the character level. The character level editing output is then reassembled into elements or fields that pass through the element or field level editing module. Finally, the fields are reassembled into forms that may be edited prior to placing the data into the database. A moderately complex editing path example could include a verification module that provides consistency checks after the reassembly of the elements. The consistency checks typically would include such things as a set of regular expressions for addresses, phone numbers and social security numbers, and a comparison of results with city names in a lexicon. Double verification may optionally be included at the element editing and full form element editing levels in order to assure high accuracy rates.

A complex editing path might include scoring-based paths for character recognition and consistency checks that span multiple fields within a form. Poor scoring results of the OCR may be used to require double data entry at the element level, whereas high confidence levels based on scoring and appropriate consistency may be used to pass directly on to full form element processing or even to document reconstruction. Because of the variability in quality of the substrate forms, due to, for example, speckling, skewing, noise, inaccurate placement of data (e.g., typing or writing on or across structural lines), and the variable use of different fonts and/or different handwriting, the more complex process provides flexibility, in that data may be reprocessed using modified or completely different processing, filtering, and recognition algorithms in automated fashion. Such reprocessing is typically invoked based on scoring thresholds and/or other useful criteria.

The editing subsystem is comprised of a number of editing modules, which are the programs and processes that present images of the output of the related recognition modules in an editable form to the editor for viewing and correction. In the preferred embodiment, the editing modules include automated processing, character level processing, element level processing, and full form level processing.

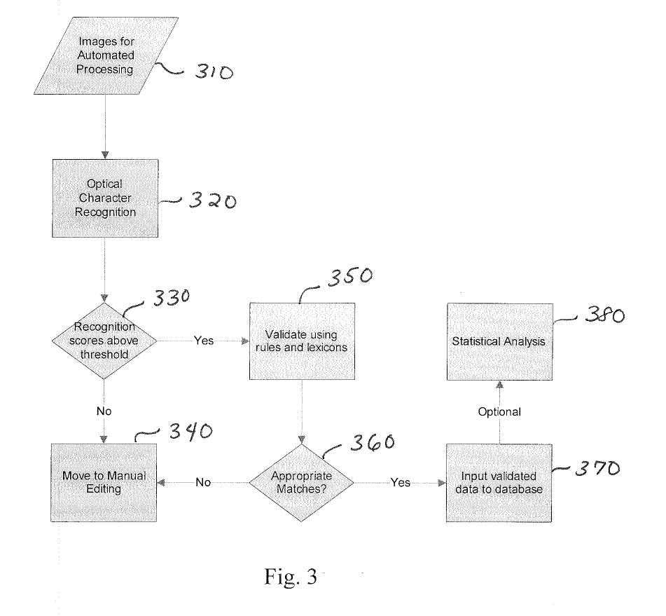

The automated processing module takes the output of recognized machine print and validates the output against rules and lexicons if the scores for the output are better than a predetermined threshold. This module requires no manual editing or viewing and is most effective for easily validated elements and fields, such as address parts (city, state, zip), fields with small lexicons (Boolean, limited lexicons) and fields that are redundant within a document. FIG. 3 is a block diagram of a preferred embodiment of an automated processing module. In FIG. 3, images identified for automated processing 310 are recognized 320 by OCR or any other suitable process known in the art. If the recognition scores are not above a predetermined threshold 330, the data is sent for manual editing 340. If the scores are above the threshold, the data is validated 350 using rules, lexicons, or any other suitable methodology known in the art. If appropriate matches are found 360, the validated data is entered 370 into the database, with or without optional statistical analysis 380. Otherwise the data is sent for manual editing 340.

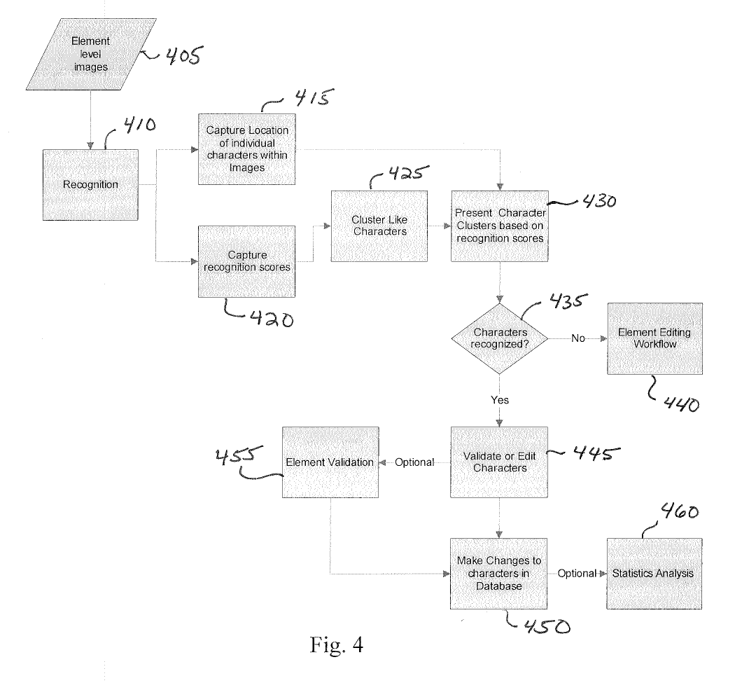

A block diagram of a preferred embodiment of a character level processing module is shown in FIG. 4. In FIG. 4, element level images 405 are recognized 410, producing images 415 of individual characters defined by location data generated during segmentation in the recognition process and recognition scores 420. The recognition results are clustered 425 based on assumed correct character identity. The clusters are presented 430, indexed by the recognition scores, preferably in a tabular view. If the characters are not recognized 435, such as if the identity of the image is unclear, the image will be passed to a different level of editing, such as the element editing workflow 440. If they are recognized 435, the character is passed to validation/editing 445. Errors may be quickly edited 450 to correct incorrect identifications. Editing may be manual (human) and/or automated, such as, but not limited to, invoking another recognition algorithm in order to handle a different font. After all images within an element are recognized, the completed element may be moved to element validation 455 within the element editing workflow or, depending upon the accuracy and validation needs of the project, may be directly entered into the database. As with all levels of editing, statistical analysis 460 may be performed using the statistical analysis module.

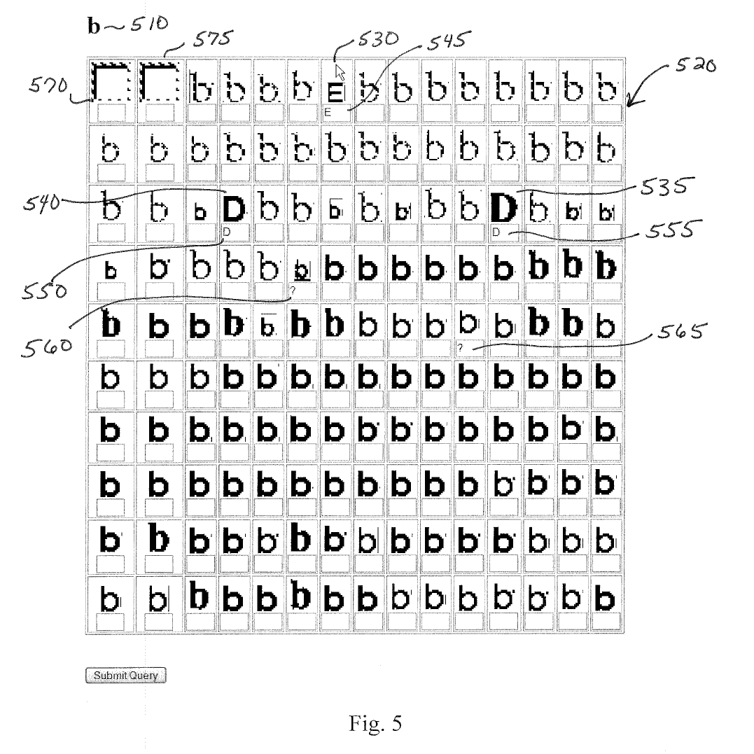

A screenshot depicting an exemplary embodiment of the editing user interface for character level editing is shown in FIG. 5. In FIG. 5, the user interface for the character “b” is shown with a representative set of images. Expected value 510 is shown in the upper left corner of the interface. Set 520 is indexed by OCR score. In this manner, most of the potential error calls are near the top of the table, so that may be instantly seen by the editor and, if necessary, may be corrected quickly. As the editor continues down the table, the characters are displayed by increasing confidence scores, and thus the probability of encountering incorrect calls is reduced. Navigation is preferably accomplished by tabbing, arrow keys, or the mouse. In the example shown, several incorrect calls 530, 535, 540 were made by the OCR engine (E, D, D) and corrected by putting in the correct calls below each images in a small text box 545, 550, 555. In addition, two unknown images 560, 565 were labeled with “?”, indicating ambiguity in the editor's viewpoint. In addition, the first two images 570, 575 correspond to non-characters, and hence were labeled with a box, as produced by using the space bar. Text boxes that are not changed are deemed to be correct.

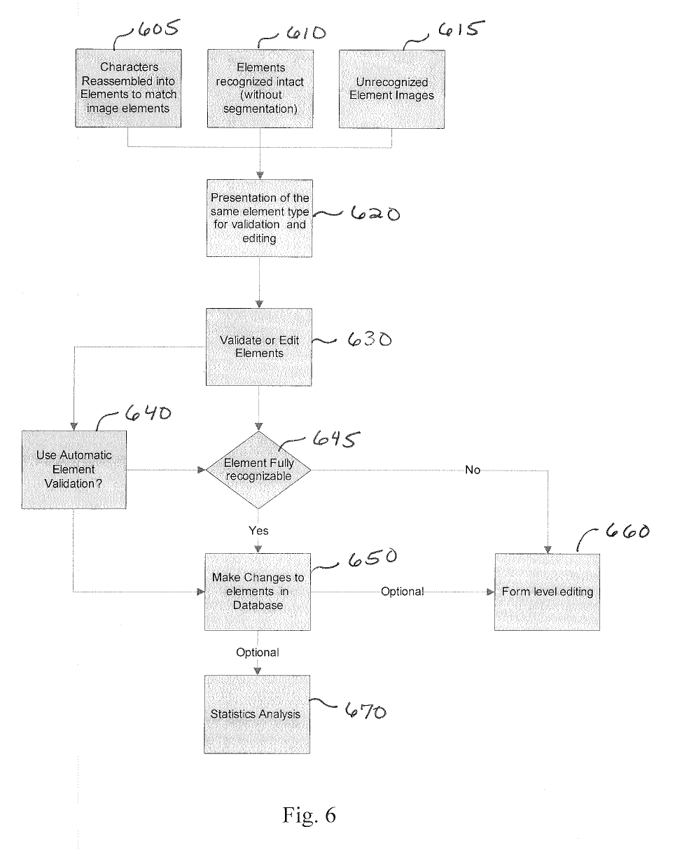

FIG. 6 is a block diagram of a preferred embodiment of an element level processing module. As shown in FIG. 6, multiple sources of images and recognition results exist for the element level processing module. Character level images and results 605 may be used after undergoing the character level editing. Intact elements 610, after recognition but not subject to character level editing, may also be used as a source, as may unrecognized element images 615, such as those with handwriting. Elements may optionally be pre-processed to remove labels and artifacts, and element boundaries may be expanded to include content that extends outside of the normal element boundaries.

In all cases, the element images are generally clustered, based on element ID or type, for presentation 620 for validation and editing 630. For example, all the address fields may be clustered. The clustering may be from the same form type, or across forms—an approach that is particularly useful for fields that contain dates and addresses. The indexing of the clustered elements may be done using the recognized results based on chronology, alphabetical, or any other suitable criteria. The indexed element images and the recognized results, if available, are preferably presented in a tabular form to maximize speed of viewing and editing.

Validation may be performed automatically 640, based on available rules and lexicons. Once the elements are completely recognized 645, edited and validated, changes 650 may be made to the database with the results. Alternatively, depending upon the accuracy and validation requirements, the element images and calls may be moved into the full form element level editing module 660 in order to supply the editor with more context for editing and validation. Element level editing may be either or both manual or automated, e.g., the use of regular expression and relational logic in order to correctly quality assure or edit a given field type. As with all levels of editing, statistical analysis 670 may be performed using the statistical analysis module.

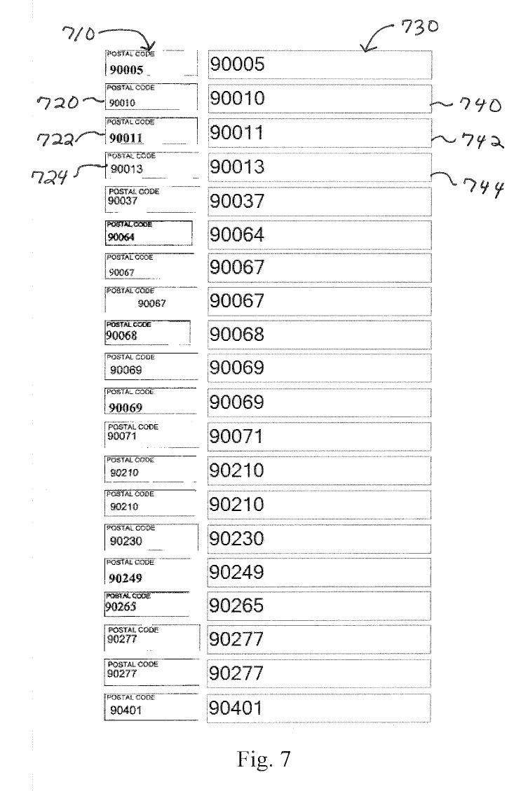

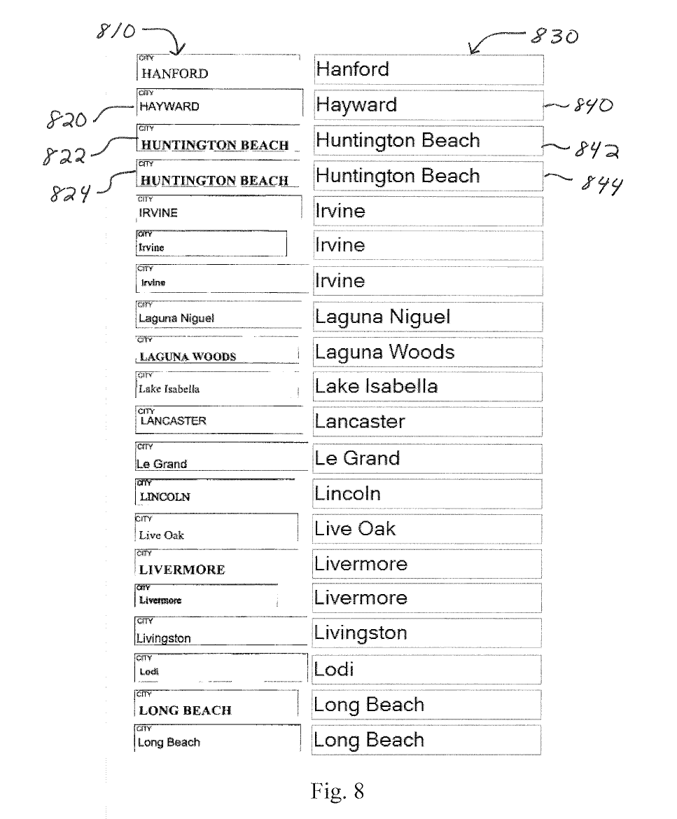

Two examples of the element level editing user interface are shown in FIGS. 7 and 8. FIG. 7 depicts the user interface for element level editing of a specific field, in this case the postal code field. Column 710 on the left contains the images 720, 722, 724 as extracted from the documents, and column 730 on the right contains corresponding text boxes 740, 742, 744 that are populated with the recognition and any previous editing results. In this example, the images and their corresponding text boxes are optionally indexed by increasing number, allowing for rapid identification of incorrect data in the text boxes. FIG. 8 depicts the user interface for element level editing of a specific field, in this case the city field. Column 810 on the left contains images 820, 822, 824 as extracted from the documents, and column 830 on the right contains text boxes 840, 842, 844 that are populated with the recognition and any previous editing results. In this example, the recognition results were optionally compared against a California city name lexicon, providing a consistency check. The images and their corresponding text boxes are optionally indexed by alphabetical order, allowing for rapid identification of incorrect data in the text boxes. Due to the consistency check, no errors were noted.

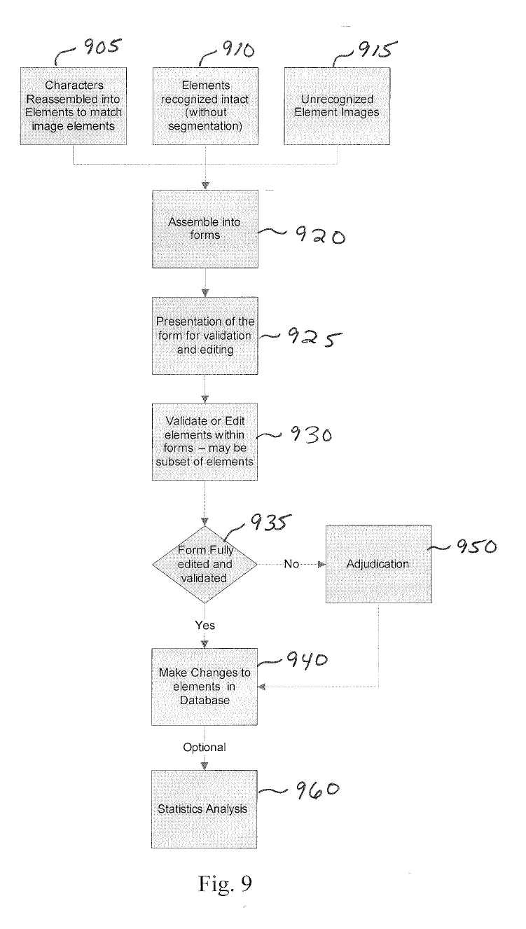

FIG. 9 is a block diagram of a preferred embodiment of a full form element level processing module. As shown in FIG. 9, the source of materials for the full form element level editing includes characters recognized and processed through character level editing 905, elements that have been processed through element level editing 910, and unrecognized element images 915, which in some cases include all the elements within a form. The results of the prior editing are matched 920 to the elements within the forms. The forms are then presented 925 with some means of highlighting the element currently being validated or edited. In a simple case, the box containing the element is surrounded with a colored border. The corresponding text entry box then allows the editor to add or change 930 the data in the box. In addition, there exists the means to rapidly navigate between the elements being edited. In many cases, not all of the existing elements in a page or form may require editing at this stage, hence the navigation is restricted to only those elements requiring validation and/or editing 930, which can be based on scoring or confidence intervals. If the elements within the form are deemed correct 935, then the appropriate changes to the data may be entered 940 into the database. Otherwise, the form may be moved to other editing modules, such as adjudication module 950 for final corrections. In addition, statistical analysis processes 960 may be performed to determine estimated accuracy and efficiency rates.

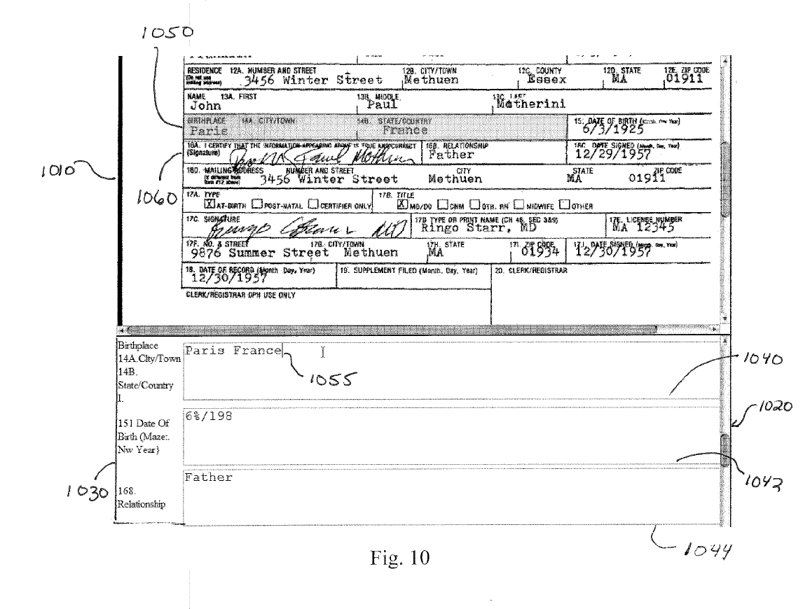

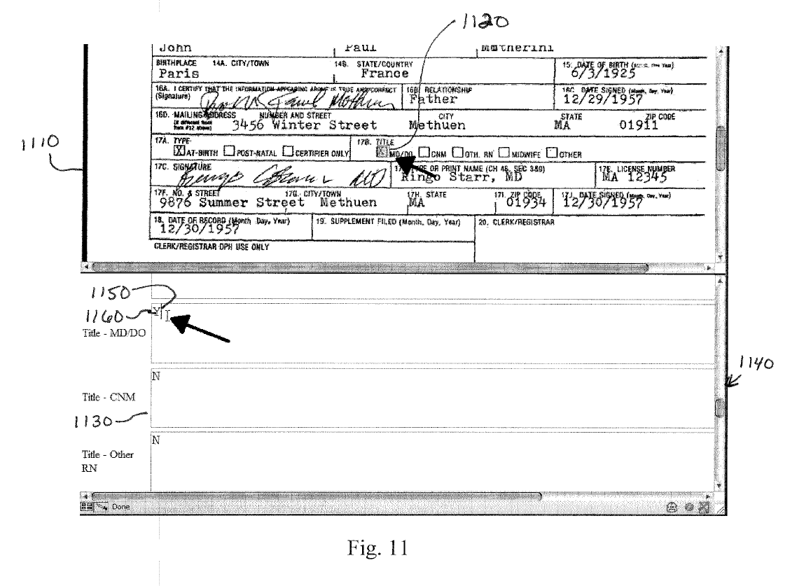

FIGS. 10 and 11 are screenshots depicting exemplary full form element level processing. FIG. 10 depicts a full form element level edit user interface in which top frame 1010 contains the image of the document and the bottom frame 1020 contains the editing panel. Example editing panel 1020 has the labels 1030 of the element located on the left and text boxes 1040, 1042, 1044 that correspond to those elements on the right. In this example, element 1050 containing the Birthplace (city/town and state/country) is highlighted and text box 1040 corresponding to that element has cursor 1055, available for editing. Additionally, it can be seen that the element “16A. Signature” 1060 is not available for editing, having no text box or label. As the editor tabs through the document, that element will be skipped. In this case, the handwriting (signature) will not be recognized, due to its input type. Recognition algorithms higher up in the process have already determined this input instance to be handwriting and so the image has been correctly routed to the proper processing path.

FIG. 11 depicts another simple full form element level editing user interface. In frame 1110 by the top arrow, box “Title: MD/DO” 1120 is highlighted with a grey overlay. Corresponding text box 1130 in lower frame 1140 has cursor 1150. The editor tabs or moves between elements and cursor 1150 will move to the correct text box for editing or data entry. In this case, the module has recognized that the input for the field is a Boolean, and returns a “Y” 1160.

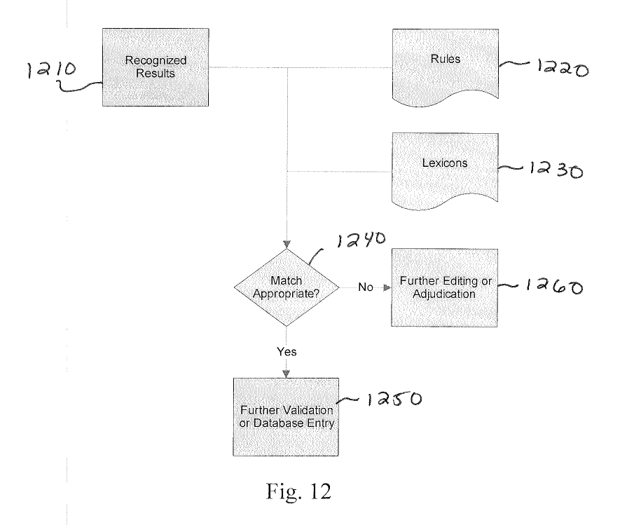

Testing and Validation Modules are processes that assist in achieving the accuracy rates required for the project. A block diagram of a preferred embodiment of a consistency checking module is shown in FIG. 12. As shown in FIG. 12, this module is generally automated, with two sources of defined input used for analysis. Results 1210 generated by recognition and/or editing are compared with field or element specific rules 1220, such as appropriate regular expressions. Additionally, in cases where redundant or related data exist, rules may be developed that use the data for comparisons. Field specific lexicons 1230 may also optionally be utilized to identify recognition or editing errors. If the match is appropriate 1240, the input is sent for further validation or database entry 1250. If not, it is sent for further editing or adjudication 1260. Autocorreaction of most, if not all, of the city names is possible by employing a comparison with the lexicon of California city names.

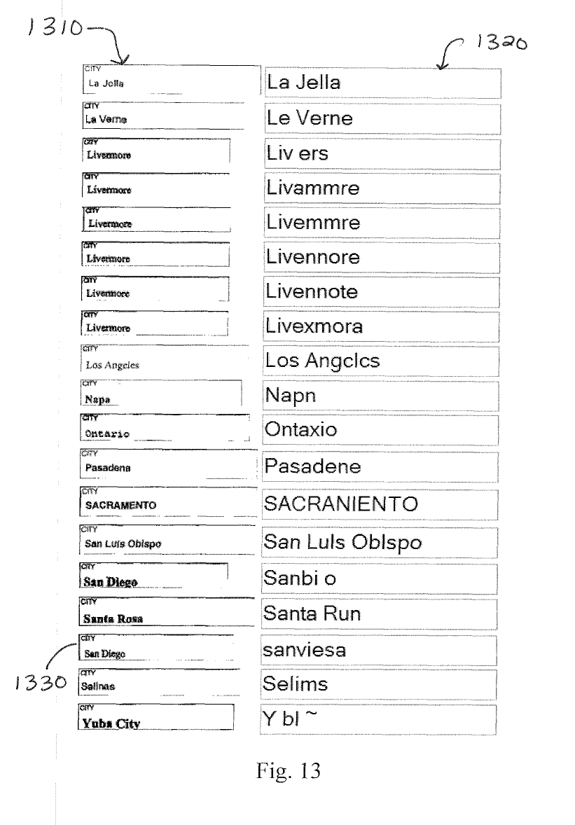

FIG. 13 is a screenshot depicting the use of consistency checks to automatically find recognition errors using a lexicon of cities and towns in California. In FIG. 13, a set of images is shown having incorrect OCR results that were caught by consistency checking, specifically by using a lexicon of cities within California. Recognized output that did not match the allowed lexicon for cities and towns in California are grouped and shown here, with the original data shown in left column 1310 and the incorrect recognized data shown in right column 1320. For example, it can quickly be seen that the second San Diego input 1330 is incorrect due to its incorrect placement in the alphabetically ordered list.

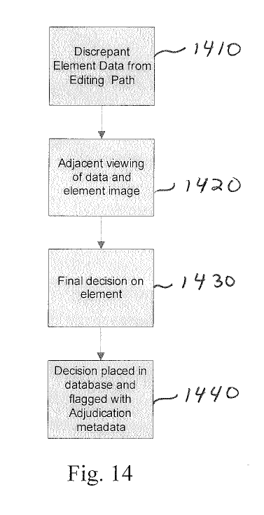

Adjudication processes may be employed when the recognition and editing, either at the automated or manual levels, leads to discrepancies in the element data. These inconsistencies may occur in cases where the fidelity of the recognition may not concur with the intended input, such as when the originals have misspellings, typos, strikeouts, overwrites, or multiple entries in a given field, and the project specifications do not address those situations. Additionally, adjudication may be used when documents are of poor quality, making absolute identification of the input difficult, or when multiple data entries or edits are employed in the processing, with discrepant results. A block diagram of a preferred embodiment of a subsystem for implementing the adjudication process shown in FIG. 14. In FIG. 14, the element 1410 in question, as received from the editing path and usually in the context of the full form, is displayed 1420, along with the recognition and editing results. The adjudicating editor will makes the final determination 1430 and the decision is placed in the database 1440, flagged with any relevant metadata, such as, but not limited to, editor, time, place, and alternative possibilities.

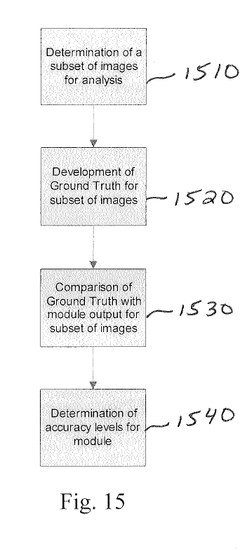

Most projects will require a specified level of accuracy of recognition. In order to provide data about the level of accuracy being achieved by each module, statistical verification is employed. A block diagram of a preferred embodiment of a subsystem for implementing the statistical verification process shown in FIG. 15. In FIG. 15, a set of images for analysis, called the subset, is identified 1510. The subset is recognized using all means necessary to generate 1520 a “Ground Truth” for the subset. The Ground Truth is considered to be 100% accurate in recognition. In an example embodiment, 1-5% of the images are randomly selected for statistical verification. At any stage in the system, the output of the stage may be compared 1530 with Ground Truth to determine 1540 the accuracy of recognition to that point in the recognition process. The determined accuracy may be determined using any of the many appropriate measures known in the art, such as the number of correct subset items from a module divided by the total number examined (subset population). In addition, accuracy levels may be generated for specific field or element types, individual characters (accuracy for the letter “a” for example), document identification, and editor accuracy. Statistical verification may therefore be used during document identification, character editing, element editing, and full form level editing to provide important data to the robustness of the process and for decisions about edit route adjustment. Furthermore, accuracy assessments may be made for each editor, and adjustments in workflows may be driven by those assessments.

An alternative, or additional, approach to statistical verification other than one based on ground truth may optionally be employed. For example, in cases where there is internal consistency among fields within a form, those fields can be checked automatically for tuples of entries that fit to lexical or regular expression rules. Identification of mismatches of data of related fields within a form may be used to determine a statistical level or accuracy. Examples of what might be checked include, but are not limited to, whether Towns/Cities match with States and Counties, whether Addresses have appropriate Zip codes and area codes, Gender may be checked against a lexicon of first names, Related dates may be cross-checked, and Related Names may be checked (such as the last names for a family). Furthermore, in cases where there are related forms or documents within a larger assembly, such as a folder or set of related documents, fields may be validated through the documents. The automated assessment of those fields may also be used for statistical analysis of accuracy.

The system provides multiple mechanisms for optimizing editing efforts based on speed and accuracy. The structure, presentation, grouping, and sorting of data can all be used increase speed and/or accuracy. For example, high accuracy may be accomplished using redundant data entry from separate editors using the same presentation, or by multiple stages of single data entry using different presentations. Furthermore, the path an element takes through the overall workflow can be dependent on the manipulations done at one of the stages. In order to achieve this flexibility, the system permits editing stages to be chained together using various rules and transitions. The editing stages start with detailed recognition information that is captured for each element on the form. For each character, the location in the source image and confidence score is stored, allowing editing and changes to be tracked.

One embodiment of the invention uses a file that describes the various stages in the workflow, as well as the transitions among the stages. Within the description, conditionals are used to allow branching events and alternative paths through a general workflow. This modularity and flexibility may be accomplished in any of the number of ways known in the art. In one embodiment, the system uses an xml file, but could easily be done with other standard data containing methods, such as a database table, a flat file, or an excel file. An example of a portion of the module that handles part of one state transition in a preferred implementation is shown in Table 1.

```
TABLE 1
<state id=“CharacterDiscarded”>
  <onentry>
  <if cond=“${_eventdata.reason eq ‘H’}”>
    <kyos:processStep name=“promoteCharWorkunit”
    processType=“sync”
      processClass=“net.kyos.transform.qc.PopulateWorkunits”>
      <kyos:parameters queryWorkflow=“C” createWorkflow=“H”
imageCaching=“false” />
    </kyos:processStep>
    <send event=“handwriting” />
    <elseif cond=“${_eventdata.reason eq ‘R’}” />
    <kyos:processStep name=“deleteWorkUnits” processType=“sync”
      processClass=“net.kyos.transform.qc.PopulateWorkunits”>
      <kyos:parameters />
    </kyos:processStep>
    <send event=“remove” />
    <else />
    <kyos:processStep name=“promoteCharWorkunit”
    processType=“sync”
      processClass=“net.kyos.transform.qc.PopulateWorkunits”>
    <kyos:parameters queryWorkflow=“C” createWorkflow=“E” />
    </kyos:processStep>
    <send event=“manual” />
  </if>
  </onentry>
  <transition event=“remove” target=“Complete” />
  <transition event=“manual” target=“ManualElement” />
  <transition event=“handwriting” target=“Handwriting” />
</state>
```

This portion of the code provides a template for the events that can happen when a new workunit enters the character discarded stage. Depending upon the mode of discarding the character, based on a user input of a function key, the character may be moved using the send event to three different stages: handwriting (which targets the Handwriting stage), remove (which targets the Complete stage), or manual (which targets the Manual Element stage).

An aspect of the invention that provides optimization of the accuracy rates and speed of editing is the ability to extract the content and divide and then group it into a level at which the ability of both computers and humans to edit data is optimized. In this aspect, grouping of characters provides a very fast means of catching errors from the OCR processes through the grouping, sorting, and presentation of the characters to a human. A key element of this process is the ability to isolate and display the characters in the appropriate editing stages, and then, after either human or further machine intervention, substitute the corrected characters into the strings as needed. The strings may be then moved into specific editing stages, also depending upon both identity of the string, the previous editing events, and the need for accuracy versus speed of editing. The code for generating character workunits in a preferred implementation is shown in Table 2.

```
TABLE 2
public void createNewCharWorkunits(ElementData srcData) throws
Exception {
  PlanarImage
  img =getDocumentPartImage(srcData.getDocumentPartId( ), false);
  List<ElementData> destList = ElementData.loadBySource(srcData);
  for (ElementData destData : destList) {
    if (destData == null || destData.getLength( ) == 0) { continue; }
    org.w3c.dom.Document convDoc =
      XMLObject.stringToDOM(destData.getSource( ));
    XPathFactory factory = XPathFactory.newInstance( );
    XPath xpath = factory.newXPath( );
    NodeList ocrNodes = (NodeList)
xpath.evaluate(“/Conversion/Source[@type=‘ElementData’]/Details/result/
ocrData”, convDoc,
      XPathConstants.NODESET);
    if (ocrNodes.getLength( ) != 1) continue;
    Element ocrNode = (Element) ocrNodes.item(0);
    if (ocrNode.getFirstChild( ) == null) continue;
    OcradResult ocrRes = new
OcradResult(ocrNode.getFirstChild( ).getNodeValue( ), true);
    GraphicLocator gLoc = new
    GraphicLocator(new String(srcData.getData( )));
    List<OCRString> ocrStrs = ocrRes.getOCRStrings( );
    String value = new String(destData.getData( ));
    log.info(“LENGTH: ” + ocrStrs.size( ) + “ vs ” + value.length( ));
    int v = 0;
    for (int k = 0; k < ocrStrs.size( ); ++k, ++v) {
      OCRString ocrStr = ocrStrs.get(k);
      if (v >= value.length( )) {
        log.error(“strs longer than value at
        element ” + destData.getId( ));
        log.error(“Last str was ” + ocrStr.getGuessedString(0));
        break;
      }
      char chr = value.charAt(v);
      if (chr == ‘ ’ || chr == ‘\n’) continue;
      int guessNum = −1;
      String guess = null;
      for (int j = 0; j < ocrStr.getGuessCount( ); ++j) {
        guess = ocrStr.getGuessedString(j);
        String vSub = value.substring(v, Math.min(value.length( ), v +
guess.length( )));
        if (guess.equals(vSub)) {
          guessNum = j;
          break;
        }
      }
      Rectangle bounds = ocrStr.getBounds( );
      bounds.translate(gLoc.getX( ), gLoc.getY( ));
      PlanarImage charImage = ImageUtil.cropImage(img, bounds);
charImage = ImageUtil.translateImage(charImage,-
      charImage.getMinX( ),charImage.getMinY( ));
      WorkUnit unit = new WorkUnit( );
      unit.setSourceDocumentPartId(srcData.getDocumentPartId( ));
      unit.setSourceElementData(srcData);
      unit.setElementData(destData);
      unit.setElementInstanceId(destData.getElementInstanceId( ));
      unit.setWorkType(WorkUnit.TYPE_CHARACTER);
      unit.setWorkFlow(this.createWorkflow);
      unit.setInitialValue(guess);
      unit.setBounds(bounds);
      unit.setImageData(ImageUtil.encodeImage(charImage,
      unit.getMimeType( )));
      unit.setCharOrder(Integer.valueOf(k));
      if (guessNum > −1) {
        unit.setScore(new Double(ocrStr.getGuessScore(guessNum)));
      } else {
        log.error(“Error: char ”‘ + chr + ’“
          from value not found in edata ” +
          destData.getId( ) + “ first guess was ” +
          ocrStr.getGuessedString(0));
        unit.setScore(Double.valueOf(7.0));
      }
      unit.save( );
      if (guess.length( ) > 1) v += guess.length( ) − 1;
    }
  }
}
```

Recombining the edited characters back into a string that matches the element field is accomplished after all associated workunits have been completed. The code that accomplishes the recombination in a preferred implementation is shown in Table 3.

```
TABLE 3
public String generateCharacterValue(ElementData srcData,
ElementData destData) throws KyosException {
  WorkUnit complete = new WorkUnit( );
  complete.setSourceElementData(srcData);
  complete.setWorkType(WorkUnit.TYPE_CHARACTER);
  complete.setWorkFlow(this.queryWorkflow);
    List<WorkUnit> units = WorkUnit.loadMatching(complete);
    //load matching is a way to do a SQL query //based on the fields that
    were set with non-null values
  if (units.size( ) == 0) return null;
  Collections.sort(units, new WorkUnit( ).new SortByCharOrder( ));
  if (destData == null) {
    destData = ElementData.loadById(units.get(0).getElementDataId( ));
  }
  int offset = 0;
  StringBuffer value = new StringBuffer(new
  String(destData.getData( )));
  for (WorkUnit unit : units) {
    String guess = (String) unit.getInitialValue( );
    if (guess == null) guess = “”;
    String user = null;
    UserWorkUnit userUnit = UserWorkUnit.loadByWorkUnit(unit);
    if (userUnit != null) {
      user = userUnit.getUserValue( );
    } else {
      continue;
    }
    if (user == null) user = “”;
    Integer pos = (Integer) unit.getCharOrder( );
    value.replace(pos + offset, pos + offset + guess.length( ), user);
    offset += user.length( ) − 1;
  }
  return value.toString( );
}
```

The current embodiment of the present invention, which has been in commercial use since May 2008, is software-based, being implemented on a windows client, Linux server web application architecture using a PostgreSQL database. However, it will be clear to one of ordinary skill in the art that one or more aspects of the invention may be performed via hardware or manually. The invention may further be implemented on any of the many platforms known in the art, including, but not limited to, MacIntosh, Sun, Windows or Linux PC, Unix, and other Intel X-86 based machines, including desktop, workstation, laptop and server computers. If implemented in software, the invention may be implemented using any of the many languages, scripts, etc. known in the art, including, but not limited to, XML, Java and Java derivatives, such as Groovy, Jruby, and JPython, Javascript, C, C++, C#, Ruby, Python, and Visual Basic. The databases may include PostgreSQL, Oracle, MySQL, SQL Server, SQLite and many other relational and non-relational database platforms.

The present invention enables rapid, cost effective, quality conversion of data from forms and documents using automated processes combined with effective quality measurement and gating mechanisms. Data processed in this manner can be used to populate other forms and documents, other workflows, databases, business intelligence tools, and visualization and analysis schemes. This approach replaces the costly and time consuming hand entry/direct key stroking approach that is presently used to convert and transfer data from one document set to another or to manually extract data from forms into a database.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A data editing system for editing and verifying data extracted from paper documents or electronic image files, comprising:
editing subsystem, the editing subsystem capable of receiving data extracted from a paper document or electronic image file, the data having an identified data type, the editing subsystem being adapted to process the extracted data for editing according to the identified data type, the editing subsystem comprising:
automated processing utility, the automated processing utility being adapted to compare extracted data with at least one lexicon to determine if correction is required;
character level editing utility, the character level editing utility being adapted to present the extracted data at the character level in an editable form for checking and to permit correction at the character level when required;
element level editing utility, the element level editing utility being adapted to present the extracted data at the element level in an editable form for checking and to permit correction at the element level when required; and
full form element level editing utility, the full form element level editing utility being adapted to present the extracted data at the full form element level in an editable form for checking and to permit correction at the full form element level when required; and
validation subsystem, the validation subsystem being adapted to assist in achieving required accuracy rates, the validation subsystem comprising:
consistency check utility, the consistency check utility being adapted to identify errors by comparing the extracted data to at least one set of lexicons or business rules; and
adjudication utility, the adjudication utility being adapted to resolve incongruencies in extracted data.

2. The data editing system of claim 1, wherein the extracted data received by the editing subsystem is recognized extracted data.

3. The data editing system of claim 1, the validation subsystem further comprising a statistical verification utility, the statistical verification utility being adapted to determine the accuracy of an editing path by comparing results from the editing path to results from an editing path known to have a predetermined accuracy threshold.

4. The data editing system of claim 3, wherein the editing path is alterable based on results obtained from the statistical verification utility.

5. The data editing system of claim 1, further comprising at least one input type identification utility, the input type identification utility being adapted to associate an input type to each element of received data previously extracted from a paper document or electronic image file and to provide the data and associated input type to the editing subsystem.

6. The data editing system of claim 5, wherein the extracted data is routed from the input type identification utility to at least one data recognition utility to obtain recognized extracted data and the extracted data received by the data editing subsystem is recognized extracted data.

7. The data editing system of claim 1, further comprising:
subsectioning utility, adapted for dividing extracted data into smaller pieces for editing; and
reconstruction utility, adapted for reassembling sectioned extracted data.

8. The data editing system of claim 1, further comprising a user statistics utility, the user statistics utility being adapted to provide management data on at least one of the operation or efficiency of the editing system.

9. A data editing system for editing and verifying data extracted from paper documents or electronic image files, comprising:
automated processing utility, the automated processing utility being adapted to compare recognized extracted data with at least one lexicon to determine if correction;
character level editing utility, the character level editing utility being adapted to present the recognized extracted data at the character level in an editable form for checking and to permit correction at the character level;
element level editing utility, the element level editing utility being adapted to present the recognized extracted data at the element level in an editable form for checking and to permit correction at the element level; and
full form element level editing utility, the full form element level editing utility being adapted to present the extracted data at the full form element level in an editable form for checking and to permit correction at the full form element level.

10. The data editing system of claim 9, wherein the extracted data received by the editing system is recognized extracted data.

11. The data editing system of claim 9, further comprising at least one input type identification utility, the input type identification utility being adapted to associate an input type to each element of extracted data.

12. The data editing system of claim 11, wherein the extracted data is routed from the input type identification utility to at least one data recognition utility to obtain recognized extracted data and the extracted data received by the data editing system is recognized extracted data.

13. The data editing system of claim 9, further comprising a validation subsystem adapted to assist in achieving required accuracy rates, the validation subsystem comprising:
consistency check utility, the consistency check utility being adapted to identify errors by comparing the extracted data to at least one set of lexicons or business rules; and
adjudication utility, the adjudication utility being adapted to resolve incongruencies in extracted data.

14. The data editing system of claim 13, the validation subsystem further comprising a statistical verification utility, the statistical verification utility being adapted to determine the accuracy of an editing path by comparing results from the editing path to results from an editing path known to have a predetermined accuracy threshold.

15. The data editing system of claim 14, wherein the editing path is alterable based on results obtained from the statistical verification utility.

16. A method for editing and verifying data extracted from paper documents or electronic image files, comprising the steps of:
receiving extracted data having an identified data type;
processing the extracted data for editing, according to the identified data type, comprising at least one of the steps of:
comparing the extracted data with at least one lexicon to determine if correction is required;
presenting the extracted data in an editable form for checking and correction at the character level, the element level, or the full form element level;
presenting the extracted data in an editable form for checking and correction at the element level; and
presenting the extracted data in an editable form for checking and correction at the full form element level; and
correcting errors in the extracted data.

17. The method of claim 16, further comprising the step of validating the checked and corrected data by the steps of:
performing a consistency check to identify errors by comparing the corrected extracted data to at least one set of lexicons or business rules; and
adjudicating errors and incongruencies in corrected extracted data.

18. The method of claim 16, further comprising the steps of:
associating the input type with each element of extracted data; and
providing the associated input type to the step of processing.

19. The method of claim 16, further comprising the steps of:
subsectioning extracted data into smaller pieces for editing; and
reassembling the sectioned extracted data after correction.

20. The method of claim 16, further comprising the step of determining the accuracy of an editing path by comparing results from the editing path to results from an editing path known to have a predetermined accuracy threshold.
